(19) United States
(12) Patent Application Publication
(10) Pub. No.: US 2017/0222267 A1
(43) Pub. Date: Aug. 3, 2017

(54) GLYCEROL ACETAL POLYETHERS AND USE THEREOF IN LITHIUM CELLS

(71) Applicant: BASF SE, Ludwigshafen (DE)

(72) Inventors: GABRIELE BAISCH, Binzen (DE); Thomas WEISS, Ilvesheim (DE); Reinhold ÖHRLEIN, Rheinfelden-Herten (DE)

(73) Assignee: BASF SE, Ludwigshafen (DE)

(21) Appl. No.: 15/126,782

(22) PCT Filed: Mar. 12, 2015
(86) PCT No.: PCT/EP2015/055150

§ 371 Date: Sep. 16, 2016

(30) Foreign Application Priority Data
Mar. 19, 2014 (EP) 14160625.1

(51) Int. Cl. H01M 10/0569; H01M 10/0525; C08G 65/334

(52) U.S. Cl. CPC H01M 10/0569; C08G 65/3344; H01M 10/0525; C08G 2650/44; H01M 2300/0028

(57) ABSTRACT

The invention relates to glycerol acetal polyethers of general formula (I) or (II), wherein R1, R2, R3, R4, R5, and n have the meaning specified in the description. Said glycerol acetal polyethers are suitable as electrolyte solvents in a lithium cell, in particular a lithium-sulfur cell. The hydroxyl content of said glycerol acetal polyethers is preferably less than 0.2 wt %. In a method for producing said glycerol acetal polyethers, glycerol acetal polyether alcohols are reacted with a C1-C18 mono- or dialkyl sulfate or C1-C18 mono- or dialkyl sulfonate in the presence of an alkaline earth.

### DESCRIPTION

The present invention relates to glyceryl acetal polyethers, to a process for preparation thereof, to a lithium cell, especially a lithium-sulfur cell, comprising these as solvents, and to the use of the glyceryl acetal polyethers as solvents in lithium cells.

In an increasingly mobile society, mobile electrical devices are becoming ever more important. For many years, batteries, especially rechargeable batteries (called secondary batteries or accumulators), have therefore been penetrating into virtually all areas of life. Secondary batteries are nowadays subject to a complex profile of demands with regard to the electrical and mechanical properties thereof. For instance, the electronics industry is demanding new, small, lightweight secondary cells or batteries having a high capacity and high cycling stability for achievement of a long lifetime. In addition, the thermal sensitivity and the self-discharge rate should be low, in order to assure high reliability and efficiency. At the same time, a high level of safety in use is required.

The use of metallic lithium as anode material is based on the low equivalent mass thereof and the associated high specific charge compared to other metals. Because of the prevalence and the associated low costs of elemental sulfur, lithium-sulfur cells are a preferred development of the lithium cell. Since elemental sulfur itself is an insulator, conductive additives such as conductive blacks or metal particles are also used in sulfur-based cathode materials. The two electrodes are connected to one another in a lithium cell using a liquid or else solid electrolyte.

Mutual electrochemical and chemical stability of electrolyte and electrode materials is achievable only using nonaqueous aprotic electrolytes. The dielectric constants are up to two orders of magnitude smaller than for protic solvents. For these reasons, increasing the electrolyte conductivity relies on the use of a conductive salt, e.g. LiClO₄, LiNO₃, LiBF₄, LiCF₃SO₃ or LiN(SO₂CF₃)₂.

Assuming a full reduction of the sulfur to lithium sulfide, in a lithium-sulfur cell, a specific capacity of 1675 Ah/kg and an energy density of 2500 Wh/kg can be expected.

The chemical reaction at the cathode can be represented in simplified form as follows:

2Li⁺+Sₓ+2e^{—}→Li⁺₂S₂^{2—},

with a decreasing number of sulfur atoms in the polysulfide anions formed as the discharge operation progresses.

The polysulfides formed have to be brought into solution and kept therein, in order that passivation of the cathode is avoided and the elemental sulfur is available for a further reduction.

The anode of the lithium-sulfur cell, as in the case of the conventional lithium cell, consists of metallic lithium. The ideal solvents should consequently be chemically inert with respect to the lithium polysulfides and lithium anode, and should have a high ability to solvate the polysulfides and a low viscosity.

C. Barchasz et al., Elektrochim. Acta. 2013, 89, 737-743 describe the electrolyte effects on the electrochemical performance of lithium-sulfur cells as a function of the solvent composition. Tetraethylene glycol dimethyl ether, 1,3-dioxolane, 1,2-dimethoxyethane, 2-ethoxyethyl ether, diethylene glycol dibutyl ether and polyethylene glycol dimethyl ether were used as solvents, and the charge capacities, dielectric constants and viscosities were determined. Diethylene glycol dibutyl ether is insufficiently conductive for use in lithium-sulfur cells, and polyethylene glycol dimethyl ether has too high a viscosity. The best ability to dissolve polysulfides is attributed to 2-ethoxyethyl ether and tetraethylene glycol dimethyl ether. The mixture of 1,3-dioxolane and 1,2-dimethoxyethane exhibits a high ion solubility, but commercial use is opposed by the low boiling points (75° C. and 85° C.) and the associated inflammability.

JP 10251400 describes the synthesis of polyoxyethylene glycols with 1,2-glyceryl carbonates as end groups and the use thereof as solvents in lithium ion cells, based on the high dielectric constants of the compounds. The compounds are synthesized proceeding from glycidyl ethers by reaction with an excess of diethyl carbonate.

It is an object of the present invention to provide a material suitable as a solvent in lithium cells, especially lithium-sulfur cells. The material should feature a high boiling point, a high flash point, a high ion conductivity and ion solubility, inertness with respect to metallic lithium and free-radical sulfur anions, ability to solvate lithium polysulfides and a low viscosity.

The production of the materials should feature the use of easily obtainable starting substances and reagents, and the avoidance of complicated purification methods. In addition, the materials should be producible in an economically viable manner and particularly in reproducible quality.

Glyceryl acetal polyethers are known per se. EP 55818, for example, describes a process for preparing polyalkylene oxide block copolymers, in which tri- or polyhydric alcohols are reacted with alkylene oxides in the presence of alkali metal and alkaline earth metal hydroxides. At least two hydroxyl groups are in protected form as the acetal or ketal in an intermediate. The target compounds are obtained after acidic hydrolysis of the acetals or ketals, and find use as surfactants, emulsifiers, demulsifiers, dispersants or wetting agents. The blocking of terminal hydroxyl groups can be effected by substitution reactions using alkyl halides in the presence of phase transfer catalysts and sodium carbonate or addition reactions with addition of monoisocyanates.

WO 2010/141069 A2 describes the synthesis of monodisperse polyethylene-lipid conjugates. The synthesis comprises the reaction of reactive polyethylene glycol oligomers protected at one end with protected glycerol derivatives. The conjugates find use in pharmaceutical formulations.

U.S. Pat. No. 4,994,626 describes a process for methylation of polyether polyols with dimethyl sulfate in the presence of an alkali metal hydroxide at temperatures of not more than 35° C. The blocking of the hydroxyl end groups was conducted in the best case in 97.6%.

Further methods for etherification of alcohols using dimethyl sulfate as alkylating agent are described by S. Petursson et al., Science of Synthesis 2008, 37, 850 and A. Merz Angew. Chem. 1973, 85, 868. In both publications, said etherification is conducted in the presence of an alkali metal base and of a phase transfer catalyst. During the workup, the excess of alcohol used and the by-products formed have to be removed via an additional purification step.

JP 10095748 describes the synthesis of polyalkoxylene fatty acid esters in the presence of alkaline earth metal oxides as base. The products are purified in a costly manner using ion exchangers.

In order to be suitable for use in lithium cells, the solvents have to have a very low hydroxyl content. The known processes for preparation of glyceryl acetal polyethers do not meet this requirement.

It has been found that the problem stated above is solved in a surprising manner by glyceryl acetal polyethers of the general formula I and/or II

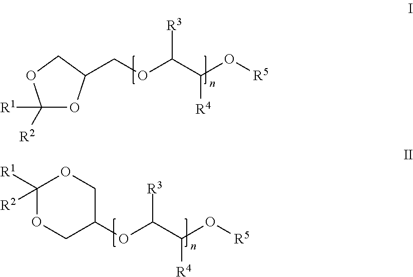

in which R¹ and R² are each independently H or C₁-C₄ alkyl or R¹ and R² together are C₃-C₅ alkylene, R³ and R⁴ are each independently H or C₁-C₄ alkyl, R⁵ is C₁-C₁₂ alkyl and n is an integer from 2 to 18, said glyceryl acetal polyethers being characterized by a hydroxyl content of less than 0.2% by weight.

The invention further relates to the use of glyceryl acetal polyethers of the general formula I and/or II

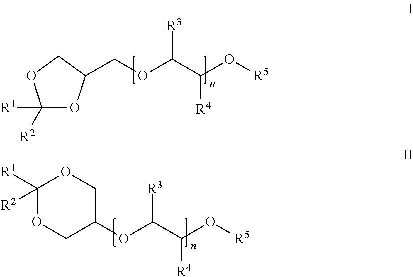

in which R¹ and R² are each independently H or C₁-C₄ alkyl or R¹ and R² together are C₃-C₅ alkylene, R³ and R⁴ are each independently H or C₁-C₄ alkyl, R⁵ is C₁-C₁₈ alkyl and n is an integer from 2 to 18, as solvents in lithium cells, especially lithium-sulfur cells.

The invention further relates to a lithium cell, especially a lithium-sulfur cell, comprising glyceryl acetal polyethers of the general formula I and/or II as solvents.

The invention further relates to a process for preparing glyceryl acetal polyethers of the general formula I and/or II by reacting alcohols of the formulae III and/or IV

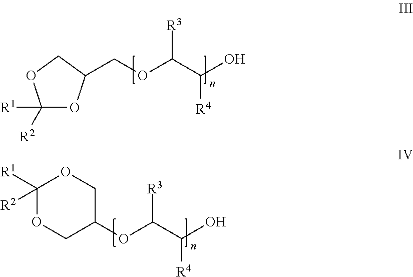

in which R¹, R², R³ and R⁴ are each as defined above with an alkyl sulfate or alkylsulfonate in the presence of an alkaline earth metal oxide.

The inventive glyceryl acetal polyethers are present either as 1,2-acetals of the formula I or 1,3-acetals of the formula II or as mixtures thereof. Mixtures of the 1,2-acetals of the formula I and 1,3-acetals of the formula II constitute a preferred embodiment of the invention. In the mixtures, the glyceryl acetal polyethers of the formula I and the glyceryl acetal polyethers of the formula II may be present, for example, in a weight ratio of 1/99 to 99/1, preferably 10/90 to 90/10.

The R¹ and R² radicals are either hydrogen atoms or C₁-C₄ alkyl. Alternatively, R¹ and R² together may be C₃-C₅ alkylene. Alkyl here is especially methyl, ethyl, n-propyl, 1-methylethyl, n-butyl, 1-methylpropyl, 2-methylpropyl, 1,1-dimethylethyl. If R¹ and R² together are C₃-C₅ alkylene, they form, together with the carbon atom to which they are bonded, a spiro-bonded cyclobutane, cyclopentane or cyclohexane ring.

The invention further relates to a process for preparing glyceryl acetal polyethers of the general formula I and/or II by reaction of alcohols of the formulae III and/or IV

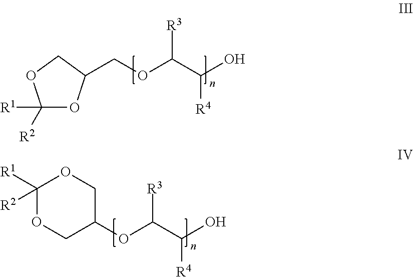

in which R¹, R², R³ and R⁴ are each as defined above with an alkyl sulfate or alkylsulfonate in the presence of an alkaline earth metal oxide.

Preferably, R¹ and R² are each hydrogen or methyl, especially hydrogen.

R³ and R⁴ are each independently H or C₁-C4 alkyl. Alkyl here is especially methyl, ethyl, n-propyl, 1-methylethyl, n-butyl, 1-methylpropyl, 2-methylpropyl, 1,1-dimethylethyl. Preferably, R³ and R⁴ are each hydrogen or methyl, especially hydrogen.

R⁵ is C₁-C₁₈ alkyl. Alkyl here is especially methyl, ethyl, n-propyl, 1-methylethyl, n-butyl, 1-methylpropyl, 2-methylpropyl, 1,1-dimethylethyl, n-pentyl, 1-methylbutyl, 2-methylbutyl, 3-methylbutyl, 2,2-dimethylpropyl, 1-ethylpropyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl and 1-ethyl-2-methylpropyl; and also n-heptyl, n-octyl, n-nonyl and n-decyl, n-dodecyl, and the singly or multiply branched analogs thereof. Preferably, R⁵ is C₁-C₁₂ alkyl, especially C₁-C₄ alkyl, more preferably methyl.

The number of repeat units n may vary from 2 to 18, preferably 3 to 12. It has been found that, within this range, the viscosity and volatility of the compounds are advantageous for the intended end use in lithium cells.

The inventive glyceryl acetal polyethers have the particular feature of a hydroxyl content of less than 0.2% by weight. The term “hydroxyl content” in the present context is understood to mean the total hydroxyl content, i.e. the sum total of non-etherified hydroxyl groups in the glyceryl acetal polyethers and in the residual water present, based on the total weight of the glyceryl acetal polyethers.

The hydroxyl content can suitably be determined by a Karl Fischer titration (J. P. Kosonen et al., Int. J. Polym. Anal. Charact. 1998, 4, 283-293) or alternatively via mass spectrometry analyses.

In the Karl Fischer titration, the free hydroxyl groups are first methoxylated in the presence of methanol (1). The amount of water released, which is equivalent to the amount of hydroxyl groups used, is finally determined via Karl Fischer titration (2).

ROH+CH₃OH→ROCH₃+H₂O (1)

H₂O+I₂+3B+SO₂+CH₃OH→2[BH]I+CH₃[BH]SO₄ (2)

The basis of the water determination according to Karl Fischer is the observation that iodine and sulfur dioxide react only in the presence of water to give iodide and sulfate. In the conventional Karl Fischer titration, the water originates from the substance to be analyzed; in the present case, water forms as the condensation product of the reaction of hydroxyl groups with methanol. In this way, the hydroxyl content of compounds can be found via the determination of the water content.

For the use of the glyceryl acetal polyethers in lithium cells, the aim is to very substantially block the terminal hydroxyl groups of the starting material, since free hydroxyl groups can lead to impairment of the lithium electrode through reaction with the solvent.

The invention therefore also relates to a process for preparing glyceryl acetal polyethers of the general formula I and/or II, which leads to reaction products having a low hydroxyl content. The process makes use of the reaction of alcohols of the formulae III and/or IV

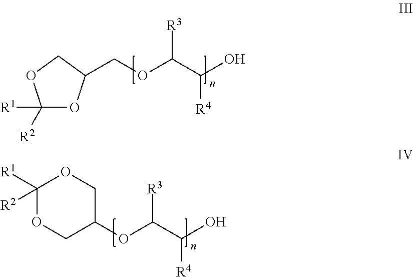

in which R¹, R², R³ and R⁴ are each as defined above with an alkyl sulfate or alkylsulfonate in the presence of an alkaline earth metal oxide.

Alkylating agents used in accordance with the invention are mono- or dialkyl sulfates or mono- or dialkylsulfonates. Preference is given to using dialkyl sulfates of the formula R⁵₂(SO₄) in which R⁵ is as defined above. Short-chain dialkyl sulfates are especially preferred, especially dimethyl sulfate.

The base used in the process according to the invention may be selected from the group of the alkaline earth metal oxides, such as BaO, MgO, CaO or SrO. Barium oxide is especially preferred for use in the process according to the invention.

The process according to the invention for preparing the glyceryl acetal polyethers is generally effected in a reaction solvent. The reaction solvent is preferably selected from polar aprotic solvents. Among these, preference is given especially to cyclic ethers, such as oxirane, tetrahydrofuran, tetrahydropyran, 1,3-dioxolane, 1,4-dioxane or crown ethers. 1,3-Dioxolane in particular is of excellent suitability as a reaction solvent in the process according to the invention. On completion of reaction, the alkaline earth metal sulfate or sulfonate formed and the reaction solvent can be removed in a customary manner. The generally sparingly soluble alkaline earth metal sulfate or sulfonate can be filtered off, optionally with the aid of filtration aids. In general, the solvent is removed after the inventive reaction by distillation under reduced pressure. Optionally, the distillative purification of the crude product is additionally necessary.

A preferred embodiment of the process according to the invention includes dissolution, at room temperature, of the alcohols III or IV or a mixture thereof in 1,3-dioxolane which already contains the alkylating agent, especially dimethyl sulfate. Over a defined period, after complete solvation of the starting material, the alkaline earth metal oxide, especially barium oxide, is added in portions. On completion of addition of the base, the reaction solution is stirred for at least 24 h up to five days. The reaction is ended by filtration through Celite. Further purification steps in the process according to the invention include a filtration through basic alumina, removal of the solvent under reduced pressure and optionally a distillation under reduced pressure. Especially for starting materials having a relatively large number of repeat units, especially with n of 10 to 15, no fractional distillation is needed for purification. For starting compounds having a smaller number of repeat units, especially with n of 2 to 5, a fractional distillation is conducted under reduced pressure, especially at 0.1 to 50 mbar.

Preferably, the base is added over a period of one hour to two hours. The reaction time for the process according to the invention may vary as a function of the number of repeat units in the starting material used. Especially when n is 2 to 5, conducting the reaction over a period of one day is the preferred embodiment. In the case of a number of repeat units of n of 6 to 15, longer reaction times are preferred, especially including two days when n is 10 or five days when n is 15.

The conversion of the alcohols ill and IV in the process according to the invention leads to an alkylation of the terminal hydroxyl groups in very high yields. Especially through methylation by the process according to the invention, for various examples, especially when R¹, R², R³, R⁴ are H and n is 2, 5, 10 or 15, the hydroxyl content of the target compounds has been reduced to a maximum of 0.2%.

The invention further relates to a lithium cell, especially a lithium-sulfur cell, comprising glyceryl acetal polyethers of the general formula I and/or II as electrolyte solvents. The cell comprises a lithium anode and preferably a sulfur-containing polymer cathode.

The term “lithium anode” in the context of the present invention is especially understood to mean that at least a portion of the anode material consists of metallic lithium. Preferably, the predominant portion of the anode material consists of metallic lithium.

The term “sulfur-containing polymer cathode” in the context of the present invention is especially understood to mean that the cathode comprises an organic polymeric material which also comprises sulfur in the form of di-, tri- or higher polysulfidic bridges or thioamides. Suitable materials are, for example, polyacrylonitrile-sulfur composites.

In addition, the cathode material may comprise at least one electrically conductive additive, for example carbon black, graphite, carbon fibers or carbon nanotubes.

Moreover, the cathode material may further comprise at least one binder, for example polyvinylidene fluoride (PVDF) or polytetrafluoroethylene (PTFE).

A cathode material slip for production of the cathode may also comprise at least one solvent, for example N-methyl-2-pyrrolidone. A cathode material slip of this kind can be applied, for example by bar coating, to a carrier material, for example an aluminum sheet or film.

The solvents of the cathode material slip are preferably removed again, preferably completely, especially by a drying process, after the application of the cathode material slip and prior to the assembly of the lithium-sulfur cell.

The cathode material-carrier material arrangement can subsequently be divided, for example by punching or cutting, into several cathode material-carrier material units.

The cathode material-carrier material arrangement or units can be assembled together with a lithium metal anode, for example in the form of a sheet or film of metallic lithium, to give a lithium-sulfur cell. The cell comprises at least one electrolyte. The electrolyte generally comprises the electrolyte solvent and at least one conductive salt. The conductive salt may be selected, for example, from the group consisting of lithium hexafluorophosphate (LiPF₆), lithium bis(trifluoromethylsulfonyl)imide (LiTFSI), lithium tetrafluoroborate (LiBF₄), lithium trifluoromethanesulfonate (LiCF₃SO₃), lithium chlorate (LiClO₄), lithium bis(oxalato)borate (LiBOB), lithium fluoride (LiF), lithium nitrate (LiNO₃), lithium hexafluoroarsenate (LiAsF₆) and combinations thereof.

The examples which follow serve to illustrate the invention.

### GENERAL WORKING METHODS

Nuclear resonance spectroscopy

The nuclear resonance spectra were recorded on the Varian instruments at 300 K. The chemical shifts are reported as δ values (ppm) and refer to the shift relative to TMS as internal standard. In the assignment of the signals and for the signal multiplicities, the following abbreviations were used: s-singlet, d-doublet, t-triplet, q-quartet, m-multiple, b-broad, virt.-virtual. In the event of coincidental equivalence of the coupling constants of non-equivalent protons, the coupling pattern was assigned according to the rules of 1st order spectra. The coupling constants J reported are reported as mean values of those found experimentally.

The Karl Fischer titration was conducted with the Metrohm Coulometer 831 according to the manufacturer's instructions. Traces of water and hydroxyl groups were determined quantitatively with a detection limit of 50 ppm for an amount of sample of at least 200 mg.

### EXAMPLE 1

### Methoxy (PEG-2) Glyceryl Formal

At room temperature, a mixture of ethoxylated (n=2) glyceryl 1,2-formal and 1,3-formal (60.0 g) was dissolved in 1,3-dioxolane (200 mL) comprising dimethyl sulfate (41.3 g, 327 mmol). Over a period of 75 minutes, barium oxide (49.0 g, 320 mmol) was added in small portions. In the course of this, the temperature rose to 30° C. On completion of addition, the reaction mixture was stirred at room temperature for 24 hours and then filtered through Celite. Celite was washed with dichloromethane and the crude product was filtered through basic alumina (100 g, Fluka 5016A). The solvent was removed under reduced pressure and the crude product was purified by distillation. At 0.1 mbar, the product fractions were collected at a boiling point of 64° C. to 125° C. The yield of the mixture of end-capped glyceryl formal polyethers was 50.0 g.

The hydroxyl content of the product was less than 0.2%.

¹H NMR (CDCl₃): δ(ppm)=3.38 (s, 3 H), 3.45-3.55 (m, 3 H), 3.60-3.73 (m, 8 H), 3.96 (t, 0.4 H), 4.09 (dd, 1.2 H), 4.23 (m, 0.4 H), 4.69 (dd, 0.6 H), 4.88 (m, 1 H), 5.02 (d, 0.4 H).

### EXAMPLE 2

### Methoxy (PEG-5) Glyceryl Formal

At room temperature, a mixture of ethoxylated (n=5) glyceryl 1,2-formal and 1,3-formal (25.0 g) was dissolved in 1,3-dioxolane (50 mL) comprising dimethyl sulfate (11.3 g, 89.5 mmol). Over a period of 75 minutes, barium oxide (12.8 g, 83.4 mmol) was added in small portions. In the course of this, the temperature rose to 30° C. On completion of addition, the reaction mixture was stirred at room temperature for 24 hours and then filtered through Celite. Celite was washed with dichloromethane and the crude product was filtered through basic alumina (100 g, Fluke 5016A). The solvent was removed under reduced pressure and the crude product was purified by distillation (0.1 mbar, 170° C.). The yield of the mixture of end-capped glyceryl formal polyethers was 20.1 g. The hydroxyl content of the product was less than 0.2%.

¹H NMR (CDCl₃): δ(ppm)=3.35 (s, 3 H), 3.42-3.55 (m, 3 H), 3.60-3.74 (m, 20 H), 3,94 (t, 0.4 H), 4.08 (dd, 1.2 H), 4.18 (m, 0.4 H), 4.64 (dd, 0.6 H), 4.82 (m, 1 H), 4.98 (d, 0.4 H).

### EXAMPLE 3

### Methoxy (PEG-10) Glyceryl Formal

At room temperature, a mixture of ethoxylated (n=10) glyceryl 1,2-formal and 1,3-formal (40.0 g) was dissolved in 1,3-dioxolane (80 mL) comprising dimethyl sulfate (11.4 g, 90.4 mmol) and water (0.18 g, 10.0 mmol). Over a period of 75 minutes, barium oxide (14.7 g, 95.9 mmol) was added in small portions. In the course of this, the temperature rose to 30° C. On completion of addition, the reaction mixture was stirred at room temperature for two days and then filtered through magnesium sulfate and Celite. Celite was washed with diethyl ether, and the solvent and volatile constituents were removed under reduced pressure, The residue was cooled, diethyl ether was added and the mixture was filtered through basic alumina (100 g, Fluka 5016A). After removal of the diethyl ether under reduced pressure, a mixture of the end-capped glyceryl formal polyethers was obtained in a yield of 20.6 g. The hydroxyl content of the product was less than 0.2%.

¹H NMR (CDCI₃): δ(ppm)=3.40; (s, 3 H), 3.45-3.58; (m, 3 H), 3.60-3.78; (m, 40 H), 3.96; (t, 0.4 H), 4.10; (dd, 1.2 H), 4.24; (m, 0.4 H), 4.70; (dd, 0.6 H), 4.88; (m, 1 H), 5.04; (d, 0.4 H).

### EXAMPLE 4

### Methoxy (PEG-15) Glyceryl Formal

At room temperature, a mixture of ethoxylated (n=15) glyceryl 1,2-formal and 1,3-formal (40.0 g) was dissolved in 1,3-dioxolane (80 mL) comprising dimethyl sulfate (8.10 g, 64.2 mmol) and water (0.10 g, 5.56 mmol). Over a period of 75 minutes, barium oxide (13.0 g, 84.8 mmol) was added in small portions. In the course of this, the temperature rose to 30° C. On completion of addition, the reaction mixture was stirred at room temperature for five days and then filtered through magnesium sulfate and Celite. Celite was washed with diethyl ether, and the solvent and volatile constituents were removed under reduced pressure. The residue was cooled, diethyl ether was added and the mixture was filtered through basic alumina (100 g, Fluka 5016A). After removal of the diethyl ether under reduced pressure, a mixture of the end-capped glyceryl formal polyethers was obtained in a yield of 16.1 g. The hydroxyl content of the product was less than 0.2%.

¹H NMR (CDCI₃): δ(ppm)=3.49; (s, 3 H), 3.42-3.58; (m, 3 H), 3.60-3.78; (m, 60 H), 3.98; (t, 0.4 H), 4.10; (dd, 1.2 H), 4.25; (m, 0.4 H), 4.70; (dd, 0.6 H), 4.92; (m, 1 H), 5.05; (d, 0.4 H).

1-14. (canceled)

15. A glyceryl acetal polyether of the general formula I or II 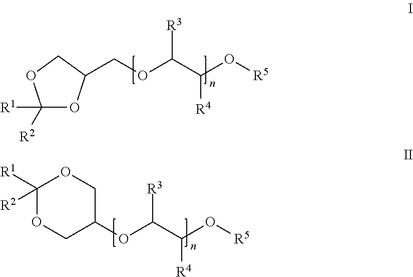
wherein R¹ and R² are each independently H or C₁-C₄ alkyl or R¹ and R² together are C₃-C₅ alkylene, R³ and R⁴ are each independently H or C₁-C₄ alkyl, R⁵ is C₁-C₁₂ alkyl and n is an integer from 2 to 18, wherein the glyceryl acetal polyether has a hydroxyl content of less than 0.2% by weight.

16. The glyceryl acetal polyether according to claim 15, wherein R¹ and R² are each H.

17. The glyceryl acetal polyether according to claim 15, in which R³ and R⁴ are each independently selected from H and methyl.

18. The glyceryl acetal polyether according to claim 15, in which R³ and R⁴ are each H.

19. The glyceryl acetal polyether according to claim 15, in which R⁵ is methyl.

20. The glyceryl acetal polyether according to claim 15, in which n is an integer from 2 to 18.

21. A process for preparing glyceryl acetal polyethers of the formula I and/or II 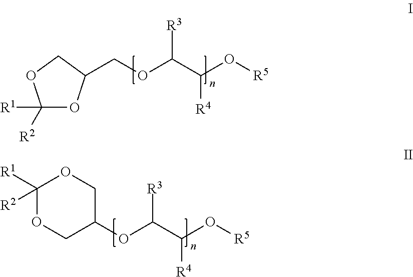
where R¹ and R² are each independently H or C₁-C₄ alkyl or R¹ and R² together are C₃-C₅ alkylene, R³ and R⁴ are each independently H or C₁-C₄ alkyl, R⁵ is C₁-C₁₂ alkyl and n is an integer from 2 to 18,
which comprises reacting alcohols of the general formulae III and/or IV 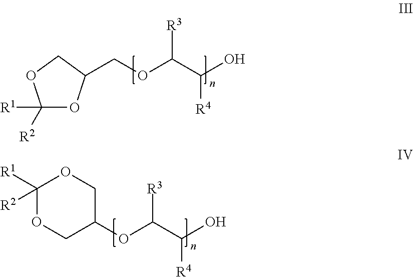
wherein R¹, R², R³ and R⁴ are each as already defined with a C₁-C₁₈ mono- or dialkyl sulfate or C₁-C₁₈ mono- or dialkylsulfonate in the presence of an alkaline earth metal oxide.

22. The process according to claim 21, wherein the reaction in a reaction solvent selected from polar aprotic solvents.

23. The process according to claim 21, wherein the reaction solvent is selected from cyclic ethers.

24. The process according to claim 21, wherein the reaction solvent is selected from the group consisting of oxirane, tetrahydrofuran, tetrahydropyran, 1,3-dioxolane, 1,4-dioxane and crown ethers.

25. The process according to claim 21, wherein the alkylating agent is selected from C₁-C₁₈ dialkyl sulfates.

26. The process according to claim 21, wherein the alkaline earth metal oxide is selected from the group consisting of MgO, CaO, SrO and BaO.

27. A lithium cell comprising the glyceryl acetal polyether according to claim 15 as electrolyte solvent.

28. The lithium cell according to claim 27, wherein the cell is a lithium-sulfur cell.
